(19) United States
(12) Patent Application Publication
(10) Pub. No.: US 2024/0114048 A1
(43) Pub. Date: Apr. 4, 2024

(54) SECURITY SERVICES FOR SMALL BUSINESSES

(71) Applicant: McAfee, LLC, San Jose, CA (US)

(72) Inventors: Dattatraya Kulkarni, Bangalore (IN); Srikanth Nalluri, Bangalore (IN); Himanshu Srivastava, Bangalore (IN); Shashank Jain, Bangalore (IN); Urmil Mahendra Parikh, Bangalore (IN); Raghavendra Satyanarayana Hebbalalu, Karnataka (IN); Piyush Pramod Joshi, Aurangabad (IN); Partha Sarathi Barik, Bangalore (IN); Purushothaman Balamurugan, Salem (IN); Saravana Kumar Ramalingam, Bangalore (IN); Devanshi Saxena, Lucknow (IN); Martin Pivetta, Dallas, TX (US); Sujay Subrahmanya, Bangalore (IN); Shahmeet Singh, Bangalore (IN); Ryan Burrows, Rivestone (AU)

(73) Assignee: McAfee, LLC, San Jose, CA (US)

(21) Appl. No.: 18/088,385

(22) Filed: Dec. 23, 2022

(30) Foreign Application Priority Data
Sep. 29, 2022 (IN) 202241055967

(51) Int. Cl. H04L 9/40

(52) U.S. Cl. CPC H04L 63/1433; H04L 63/20

(57) ABSTRACT

A computer-implemented method provides security services to an enterprise. The method computes, for a plurality of enterprise users, a plurality of user health scores based on respective protection statuses for a plurality of enterprise assets owned by respective users; computes, for the enterprise, an overall enterprise security status score based on the plurality of user health scores; graphically displays to an enterprise administrator the overall enterprise security status score; and presents to the enterprise administrator a plurality of action recommendations to improve the overall enterprise security status score.

### CROSS REFERENCE TO RELATED APPLICATION

This application claims the benefit of priority to Indian Patent Application Serial No. 202241055967, filed Sep. 29, 2022, entitled “IMPROVED SECURITY SERVICES FOR SMALL BUSINESSES,” the entire contents of which are hereby incorporated by reference in their entirety.

### FIELD OF THE SPECIFICATION

This application relates in general to computer security, and more particularly though not exclusively to security services for small businesses.

### BACKGROUND

Small businesses may require security services to operate without interference from various security threats.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a small business security ecosystem.

FIG. 2 is a block diagram representation of selected small business assets.

FIG. 3 is a block diagram of selected elements of a user device.

FIG. 4 is a block diagram illustration of selected elements of a risk assessment ecosystem.

FIG. 5 illustrates another dimension of a risk assessment ecosystem, including a user risk profile.

FIG. 6 is a block diagram representation of selected aspects of security state management.

FIG. 7 is a block diagram illustration of an illustrative user interface elements.

FIG. 8 is a block diagram illustration of selected elements of a user protection ecosystem.

FIG. 9 illustrates a dashboard that is provided to a user named John.

FIG. 10 is a block diagram illustration of a UI element.

FIG. 11 is a block diagram illustration of a UI element.

FIG. 12 is a block diagram representation of selected elements of a system.

FIG. 13 is a block diagram of selected elements of a hardware platform.

FIG. 14 is a block diagram of selected elements of a network function virtualization (NFV) infrastructure.

FIG. 15 is a block diagram of selected elements of a containerization infrastructure.

### SUMMARY

A computer-implemented method provides security services to an enterprise. The method computes, for a plurality of enterprise users, a plurality of user digital health scores based on respective protection statuses for a plurality of enterprise assets owned by respective users; computes, for the enterprise, an overall enterprise security status score based on the plurality of user digital health scores; graphically displays to an enterprise administrator the overall enterprise security status score; and presents to the enterprise administrator a plurality of action recommendations to improve the overall enterprise security status score.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Overview

As used in this specification, a small business generally includes a business with between 1 and upper bound of employees, which upper bound may be on the order of 100 to 250 employees. In some cases, a small business may be defined more particularly in terms of how it operates, such as with a “small business mentality.” Small businesses tend to be agile, less formal, and more intimate than medium to large businesses.

Small businesses may face many of the same security challenges as medium to large businesses but may not have the luxury of hiring or contracting dedicated IT managers and cyber security experts. Rather, in small businesses, the small business owner or another employee may end up taking on the burden of managing security as a part-time activity. As the security environment continues to increase in complexity with an increasing number of devices, applications, cloud services, and other considerations, small business owners and their employees may become overwhelmed with the security tasks. Furthermore, the small business owner or employee managing security may not be a full-time security expert but, rather, may have some ordinary or passing familiarity with security and thus may be tasked with managing assets that impose a substantial time and energy burden. As the number of small businesses proliferate, security threats for small businesses may become similar to those facing medium and larger enterprises.

To manage its security posture, a small business may deploy consumer solutions or, in some cases, an enterprise class solution that has been repurposed for small businesses. These approaches may have drawbacks. For example, some consumer solutions may be inadequate to meet the small business' needs. Consumer solutions may not provide a view of how assets are protected and may lack mechanisms to alert users of important security events. Consumer class solutions may also lack manageability features beyond simply turning on the security software and possibly configuring a few high-level options.

On the other hand, enterprise class security solutions may be difficult for a small business user to understand and manage and may require expertise to deploy, monitor, and manage. Enterprise class solutions may also be prohibitively expensive for some small business users.

Small business owners and operators may benefit from simplified security solutions with ease of use similar to consumer or household options, while also having a level of insight and control that provides greater confidence in their security solution. Thus, the present specification provides a system and method that is targeted specifically to the needs of small businesses.

### Selected Examples

The foregoing can be used to build or embody several example implementations, according to the teachings of the present specification. Some example implementations are included here as nonlimiting illustrations of these teachings.

Example 1 is a computer-implemented method of providing security services to an enterprise, comprising: computing, for a plurality of enterprise users, a plurality of user digital health scores based on respective protection statuses for a plurality of enterprise assets owned by respective users; computing, for the enterprise, an overall enterprise security status score based on the plurality of user digital health scores; graphically displaying to an enterprise administrator the overall enterprise security status score; and presenting to the enterprise administrator a plurality of action recommendations to improve the overall enterprise security status score.

Example 2 is the computer-implemented method of example 1, wherein the enterprise is a small business.

Example 3 is the computer-implemented method of example 2, wherein the small business has fewer than 250 employees.

Example 4 is the computer-implemented method of example 1, wherein a user digital health score is further adjusted according to notional assets of the plurality of enterprise assets.

Example 5 is the computer-implemented method of example 4, wherein the notional assets are adjustable by an enterprise administrator.

Example 6 is the computer-implemented method of example 1, wherein a user digital health score is further adjusted according to weights assigned to individual protection statuses for the plurality of enterprise assets.

Example 7 is the computer-implemented method of example 1, wherein computing a user digital health score comprises computing respective sub-scores for a plurality of protection categories, and computing a weighted sum of sub-scores, wherein each sub-score is assigned a relative weight, and the relative weights add up to 1.0.

Example 8 is the computer-implemented method of example 7, wherein the plurality of protection categories comprise security, identity, and privacy.

Example 9 is the computer-implemented method of example 8, wherein a relative weight for security is higher than a relative weight for identity, and the relative weight for identity is higher than the relative weight for privacy.

Example 10 is the computer-implemented method of example 9, further comprising computing for a user a personal digital health score that includes non-enterprise assets.

Example 10 is the computer-implemented method of example 10, wherein the relative weights for the personal digital health score are different from the relative weights for the user digital health score.

Example 12 is the computer-implemented method of example 1, wherein a user digital health score is computed as a weighted sum of asset protection scores for a plurality of assets owned by the respective users, wherein an asset protection score is computed as a weighted sum of boolean protection statuses for a plurality of protections available to an asset.

Example 13 is the computer-implemented method of example 12, wherein the user digital health score is computed as a ratio relative to a perfect user digital health score.

Example 14 is the computer-implemented method of example 1, wherein the enterprise assets are selected from a group consisting of devices, data, storage, business applications, online presence, social media, account credentials, encryption keys, digital certificates, financial assets, crypto assets, e-commerce assets, proprietary data, business identity, and personal identity.

Example 15 is the computer-implemented method of any of examples 1-14, wherein the action recommendations include one-click interfaces to realize the action recommendations.

Example 16 is the computer-implemented method of any of examples 1-14, wherein the action recommendations further comprise an indication of what will happen if an action is not taken.

Example 17 is an apparatus comprising means for performing the computer-implemented method of any of examples 1-16.

Example 18 is the apparatus of example 17, wherein the means for performing the computer-implemented method comprise a processor and a memory.

Example 19 is the apparatus of example 18, wherein the memory comprises machine-readable instructions that, when executed, cause the apparatus to perform the computer-implemented method of any of examples 1-16.

Example 20 is the apparatus of any of examples 17-19, wherein the apparatus is a computing system.

Example 21 is at least one computer readable medium comprising instructions that, when executed, implement a method or realize an apparatus as in any of examples 1-20.

Example 22 is one or more tangible, nontransitory computer-readable storage media having stored thereon executable instructions to instruct a processor circuit to: compute, for a plurality of enterprise users, a plurality of user digital health scores based on respective protection statuses for a plurality of enterprise assets owned by respective users; compute, for the enterprise, an overall enterprise security status score based on the plurality of user digital health scores; graphically display to an enterprise administrator the overall enterprise security status score; and present to the enterprise administrator a plurality of action recommendations to improve the overall enterprise security status score.

Example 23 is the one or more tangible, nontransitory computer-readable storage media of example 22, wherein the enterprise is a small business.

Example 24 is the one or more tangible, nontransitory computer-readable storage media of example 23, wherein the small business has fewer than 250 employees.

Example 25 is the one or more tangible, nontransitory computer-readable storage media of example 22, wherein a user digital health score is further adjusted according to notional assets of the plurality of enterprise assets.

Example 26 is the one or more tangible, nontransitory computer-readable storage media of example 25, wherein the notional assets are adjustable by an enterprise administrator.

Example 27 is the one or more tangible, nontransitory computer-readable storage media of example 22, wherein a user digital health score is further adjusted according to weights assigned to individual protection statuses for the plurality of enterprise assets.

Example 28 is the one or more tangible, nontransitory computer-readable storage media of example 22, wherein computing a user digital health score comprises computing respective sub-scores for a plurality of protection categories, and computing a weighted sum of sub-scores, wherein each sub-score is assigned a relative weight, and the relative weights add up to 1.0.

Example 29 is the one or more tangible, nontransitory computer-readable storage media of example 28, wherein the plurality of protection categories comprise security, identity, and privacy.

Example 30 is the one or more tangible, nontransitory computer-readable storage media of example 29, wherein a relative weight for security is higher than a relative weight for identity, and the relative weight for identity is higher than the relative weight for privacy.

Example 31 is the one or more tangible, nontransitory computer-readable storage media of example 30, wherein the instructions are further to compute for a user a personal digital health score that includes non-enterprise assets.

Example 32 is the one or more tangible, nontransitory computer-readable storage media of example 31, wherein the relative weights for the personal digital health score are different from the relative weights for the user digital health score.

Example 33 is the one or more tangible, nontransitory computer-readable storage media of example 22, wherein a user digital health score is computed as a weighted sum of asset protection scores for a plurality of assets owned by the respective users, wherein an asset protection score is computed as a weighted sum of boolean protection statuses for a plurality of protections available to an asset.

Example 34 is the one or more tangible, nontransitory computer-readable storage media of example 33, wherein the user digital health score is computed as a ratio relative to a perfect user digital health score.

Example 35 is the one or more tangible, nontransitory computer-readable storage media of example 22, wherein the enterprise assets are selected from a group consisting of devices, data, storage, business applications, online presence, social media, account credentials, encryption keys, digital certificates, financial assets, crypto assets, e-commerce assets, proprietary data, business identity, and personal identity.

Example 36 is the one or more tangible, nontransitory computer-readable storage media of any of examples 22-35, wherein the action recommendations include one-click interfaces to realize the action recommendations.

Example 37 is the one or more tangible, nontransitory computer-readable storage media of any of examples 22-35, wherein the action recommendations further comprise an indication of what will happen if an action is not taken.

Example 38 is a computing device, personal to a user associated with a small business, comprising: a processor circuit; a memory, comprising personal data and business data; and a small business security agent, comprising instructions stored on the memory to instruct the processor circuit to: compute an enterprise digital health score according to an observed presence of available protections for the business data; compute a personal digital health score according to an observed presence of available protections for the personal data; send to the small business the enterprise digital health score; and display to the user the personal digital health score, along with actionable factors that affect the personal digital health score.

Example 39 is the computing device of example 38, wherein the small business security agent further comprises instructions to receive from a small business administrator an action directive to improve the enterprise digital health score, and to carry out the action directive on the computing device.

Example 40 is the computing device of example 39, wherein the action directive comprises an instruction to install an update or a driver.

Example 41 is the computing device of example 39, wherein the action directive comprises an instruction to block a uniform resource locator (URL).

Example 42 is the computing device of example 39, wherein the action directive comprises an instruction to delete or quarantine a file.

Example 43 is the computing device of example 38, wherein the small business security agent is to not share the personal digital health score with the small business.

Example 44 is the computing device of example 38, wherein the small business security agent is further to provide, to the user, recommendations for improving the personal digital health score.

Example 45 is the computing device of example 44, wherein the small business security agent is to provide a one-click interface to carry out one or more of the recommendations.

### DETAILED DESCRIPTION OF THE DRAWINGS

A system and method for security services for small businesses will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

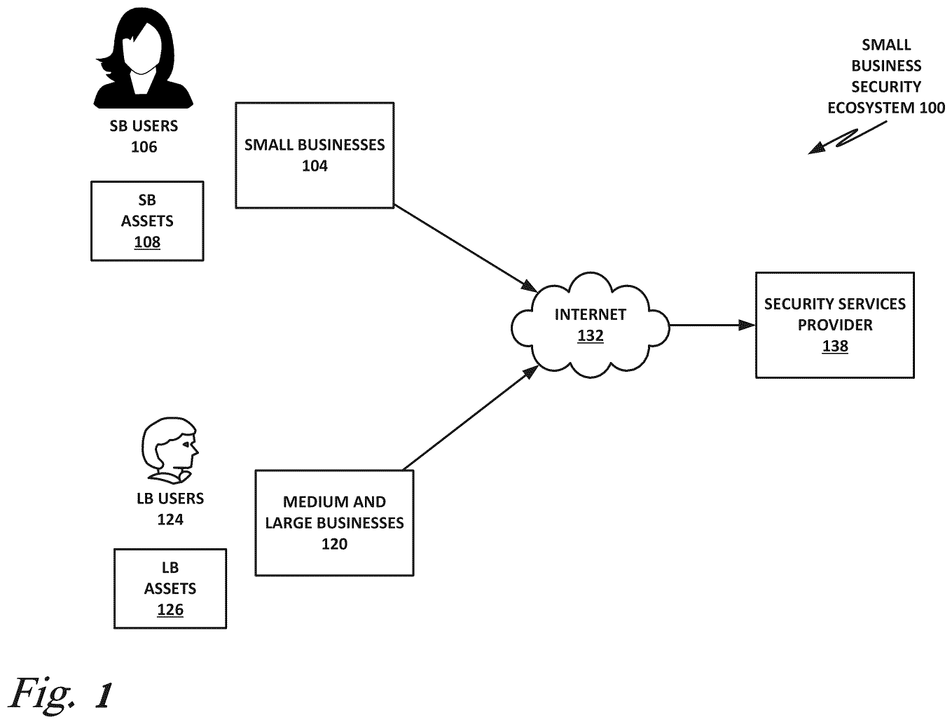

FIG. 1 is a block diagram of selected elements of a small business security ecosystem 100. Small business security ecosystem 100 may include a security services provider 138. Security services provider 138 may be an enterprise that specializes in security solutions for businesses of many different types. For example, McAfee is a leading provider of security solutions for large, medium, and small businesses, as well as for consumers.

Security services provider 138 may communicatively couple to client enterprises via internet 132. The clients may include medium and large businesses 120 as well as small businesses 104. Medium and large businesses 120 may include large business users 124 and large business assets 126 that are managed by their respective enterprises.

Small businesses 104 may likewise include small business users 106 and small business assets 108. Small businesses 104 and large businesses 120 may have vastly different available resources for managing and deploying security solutions. For example, medium and large businesses 120 may have access to dedicated security experts who focus full-time on managing security for the medium and large businesses. For some sufficiently large businesses, cybersecurity asset management may be an entire department for the business.

In contrast, small business 104 may have individual owner-operators or small employee teams and may lack a dedicated security expert. A common small business owner may not have cybersecurity certifications, specialized training in cybersecurity solutions, or dedicated expertise. Rather, the small business owner-operators and employees may be hardworking and dedicated and may have general knowledge of cybersecurity practices but may not be able to dedicate full-time efforts to managing security for the small business. It is therefore beneficial for security services provider 138 to provide to small businesses 104 a simplified view of a security posture for the small business assets. This may include, for example, users, devices, data and storage, business applications, and other assets that the small business may need to manage. Security services provider 138 may provide small business owners with simplified ways to view specific security issues and automated ways to remediate those issues. It is beneficial to provide the small business owner-operators with the ability to define simple policies and to monitor compliance to those policies both by themselves and by their employees. It is also beneficial to provide a system and associated methods that provide simplicity on par with a consumer-oriented solution, while also having a level of insight and control that provides the small business owner confidence with the small businesses security posture.

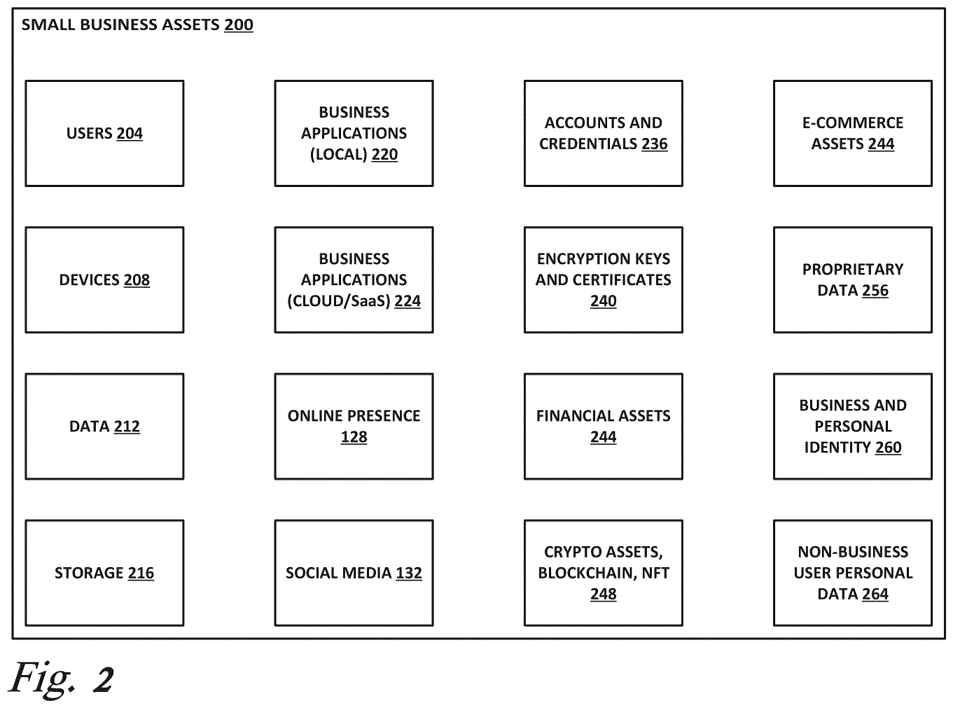

FIG. 2 is a block diagram representation of illustrative small business assets 200. As used throughout this specification, the term “asset” should be understood to include any of the assets listed here, along with any other assets that a small business may need to manage. In this example, assets include users 204, including human users, such as the small business owner-operator or the small business employees.

Devices 208 may include devices owned and operated by the small business as well as a bring your own device (BYOD) paradigm. Thus, devices 208 may represent a heterogeneous mixture of enterprise-owned assets as well as user-owned assets that perform business functions. The BYOD model is beneficial for many smaller businesses because it saves the overhead of managing and tracking physical assets. In some cases, the business owner may reimburse employees for purchasing their own computing equipment, or employees or contractors may provide their own equipment to perform business functions. While this saves overhead for the small business, it may introduce some complexities in terms of managing assets and data.

Data 212 may include data generated by the small business and may be tightly coupled with storage 216. For example, a small law firm may generate large volumes of Microsoft Word documents as well as other data, such as discovery data, client files, government correspondence, and other files and objects. These may be managed, for example, by providing a database file system or backup solution that maintains the small business data on storage 216.

The small business may also have applications including local business applications 220 and cloud or software as a service (SAAS) applications 224. For many small businesses, particularly office-based small businesses, their applications (both local and cloud-based) form a backbone of the business. This includes applications that allow the users to create and manage data 212. As in the case of devices, depending on the structure of the small business, application licenses may be owned by the employees or by the business. Businesses may also use open source applications. Tracking license compliance for both proprietary and open source applications may be a nontrivial concern for the small business.

The small business may also have an online presence 128. This may include, for example, its ownership of certain domain names, rights to control online profiles, administrative access to the business profile, such as on a review site, and other tools for managing the business' online presence.

The business may have a social media presence 132, which may include blogs, websites, and social media accounts on services such as Facebook, Instagram, Twitter, TikTok, VSCO, and others.

The business may also own certain accounts and credentials 236. This may include usernames and passwords to access certain online services and, in some cases, may be intertwined with business applications 220, cloud applications 224, online presence 128, social media 132, and other assets. Accounts and credentials may also include access to online banking sites, subscriptions to news services, and other accounts and credentials.

The small business may own a number of encryption keys and/or certificates 240. These may include, for example, encryption keys for encrypting or decrypting data 212, keys for managing encryption for websites, certificates, such as SSL/TLS certificates, for its online presence, or other keys and certificates that are used to manage data and, in particular, encrypted data.

The small business may have financial assets 244, including cash deposits, stocks, stock options, shares, investments, and other assets that are owned and controlled by the business.

In some cases, a small business may include crypto assets, such as block chain currency, nonrefundable tokens (NFT), or other cryptographic assets 248.

The small business may have e-commerce assets 244. These may include business-to-business (B2B) transactions, e-commerce sites, credit card processing accounts, and other accounts, credentials, or assets for engaging in electronic commerce.

A subset of data managed by the small business may include proprietary data 256, which may include data that are more sensitive than standard data, that contain trade secrets, business know-how, contacts, business relationships, and other data that may provide a competitive advantage to the business and that should be protected from intrusion.

The small business may also have access to and/or maintain business and personal identity 260. These data may include information about the business, information such as a taxpayer identification number, an employer identification number, Social Security numbers, telephone numbers, addresses, bank account numbers, and other information that can be used to identify the business or individuals within the business, and that may also be useful for creating and managing accounts.

The business may also have access to or be adjacent to certain nonbusiness user personal data 264. These data may be data that identify individual users, such as Social Security numbers, home addresses, phone numbers, contact information, social media accounts, usernames and passwords, and private information. In the particular instance of the BYOD paradigm, users may keep both business and personal data on a single device, and it is therefore useful for the business to segregate business data from personal data and control access in a two-way fashion. For example, the enterprise should maintain control over how and when employees access business-critical data, while also ensuring that the enterprise does not compromise the user's personal data.

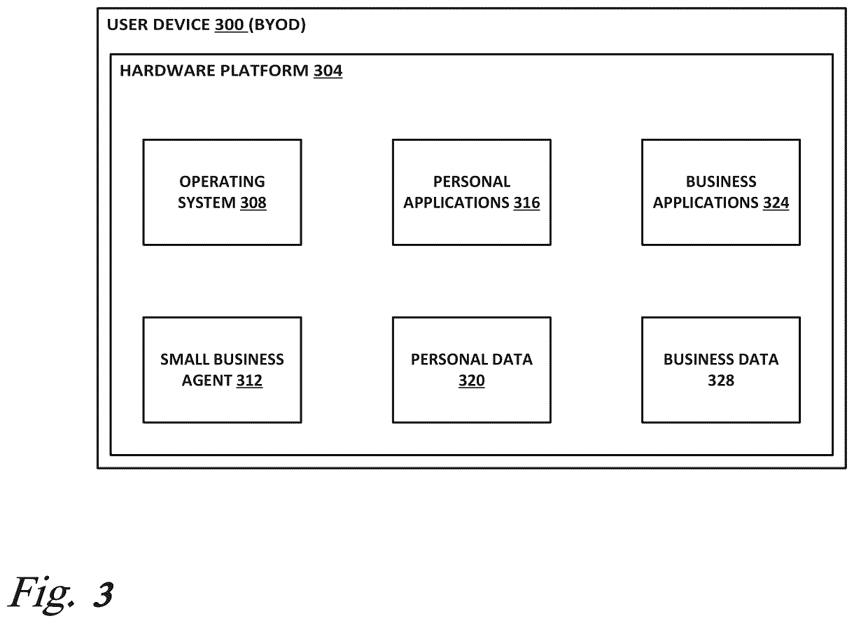

FIG. 3 is a block diagram of selected elements of a user device 300. User device 300 may be operated in a BYOD paradigm and may be physically owned by a user of the small business.

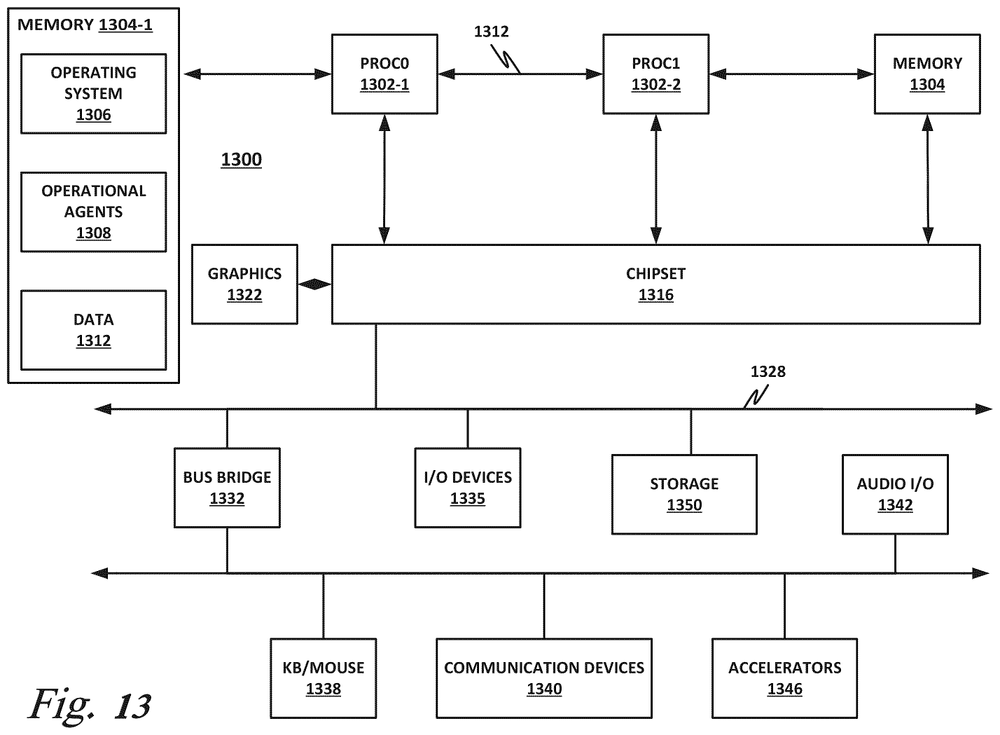

User device 300 operates on a hardware platform 304, which may be, for example, a hardware platform as illustrated in FIG. 13 below or elsewhere throughout this specification. Hardware platform 304 may provide, in general, a processor and a memory and an architecture for carrying out computing instructions.

Hardware platform 304 may have an operating system 308 and may include a small business agent 312. Small business agent 312 may be an agent installed by the small business to provide management of small business assets on the user device. Small business agent 312 may include, for example, a monitoring agent that monitors the device as well as an action agent that carries out certain actions. It is in the interest of the business and the user to ensure that small business agent 312 correctly manages business assets while protecting personal assets.

For example, user device 300 may include personal applications 316 and personal data 320. Personal data 320 are unlikely to have any relevance to the small business and are generally owned completely by the user. Personal applications 316 are often of a hybrid nature. For example, user device 300 may include an office suite that is useful for both personal business and for operating the small business. Thus, in some cases, personal applications 316 may be further subdivided into applications that are strictly personal and into hybrid applications that have both business and personal use.

User device 300 may also include business applications 324, which may be applications that are used strictly for business purposes and that have little to no relevancy for personal use. Business applications 324 are more likely, though not necessarily, owned exclusively by the small business. Business applications 324 may operate on business data 328, which may be data that are designated for use by the business and that have business implications. It may be beneficial to ensure that business data 328 and personal data 320 are not intermingled, and also to ensure that business data 328 are used only for business purposes. For example, it may be inappropriate for the small business user to access a customer list to send flyers for a personal bake sale. On the other hand, it may be inappropriate for the business to access personal data 320 that has no relevance to the business.

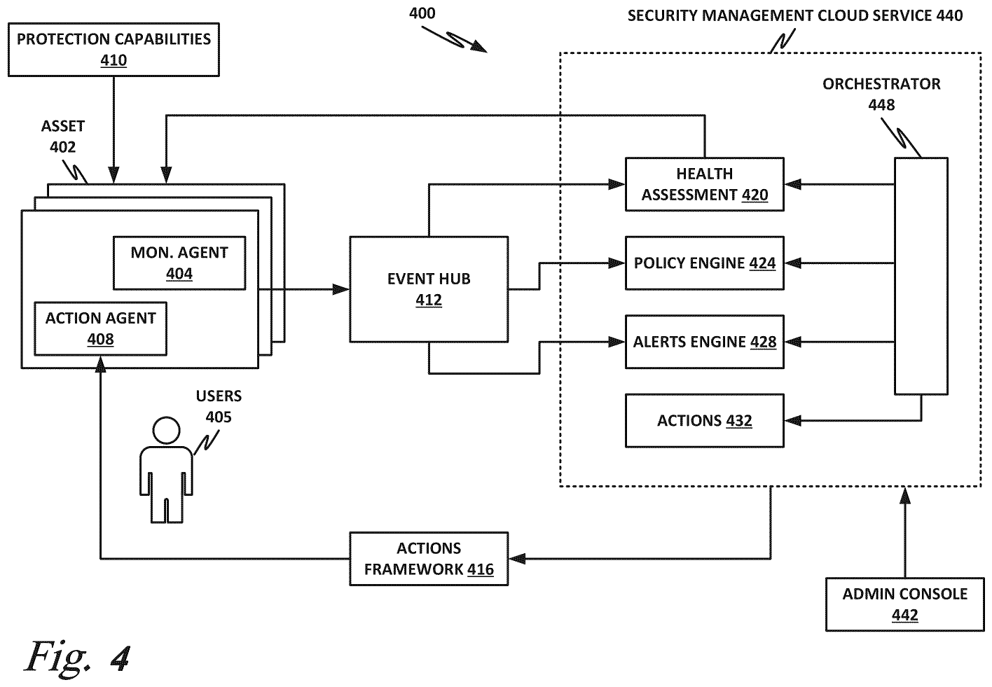

FIG. 4 is a block diagram illustration of selected elements of a risk assessment ecosystem 400. System 400 includes various functional blocks that are illustrated here according to the function that they provide, which may or may not be different from their structural physical embodiment. More particularly, the logical functions illustrated here are associated with certain operations that may be provided within a risk assessment ecosystem 400. These functions may be provided as standalone devices, such as single-purpose appliances. They may be provided as virtual machines, containers, microservices, or in any other logical configuration. In some cases, various functional blocks may be provided on the same physical device. Thus, the representation of risk assessment ecosystem 400 should be understood to be nonlimiting as to the division of labor between physical devices.

Ecosystem 400 provides a user centric view of the security of an organization. The system provides the protection state as a combined state of all the digital assets of the users that belong to the organization. Digital assets may include, by way of illustrative and nonlimiting example, devices, applications, identities (including email addresses and social media accounts), sensitive information, shared information, transactions, online accounts or services, or others. More comprehensively, additional assets are illustrated in FIG. 2 above.

Ecosystem 400 may include systems and methods to determine a user's risk profile based on an overall risk posture of all of the assets owned by or associated with the user. The risk posture may also include user behaviors, the user's role, privileges, and other factors.

Ecosystem 400 may be configured to present an overall security status as a simple health score that represents the overall health of all the users and assets in the organization. It may also provide a method that contextually defines security policies based on a user's risk profiles. The system may enforce those policies through security automation or other mechanisms.

Embodiments of ecosystem 400 may also provide a method to abstract the details of control and present a simple yet actionable construct that the small business owner can act on. This may be done without sacrificing the need for control over protection of digital assets.

Embodiments of ecosystem 400 encapsulate the complexity of the security posture into a health assessment. It may provide a policy framework for decision-making and execution by an automated action framework. Ecosystem 400 may also provide a user centric view of the security of an organization that views the security state as a combined state of all the digital assets owned by or associated with the user, including assets that belong to or that operate with the organization.

The user's risk profile may be based on overall risk posture of all the user's assets and user behaviors as they relate to security implications. The risk profile may also incorporate the user's roles and privileges. Ecosystem 400 may further provide automatic customization of the policy based on the user risk profile.

Embodiments of ecosystem 400 may recognize that many small business security models essentially follow the enterprise security paradigm. However, this may be overwhelming for small businesses where administrative experts and bandwidth may be limited. Thus, ecosystem 400 provides specific mechanisms to combine various data streams into a simplified view of the security status of the enterprise or small business. This provides a simplified and automated security management system. While this is particularly useful for small businesses, medium and large businesses may also benefit from the teachings of the present specification.

A discussion of security ecosystem 400 may begin with users 405. Ecosystem 400 may provide a security management framework that is primarily user centric. Users, in some cases, may be divided into groups for convenience. Users may also have specific roles, such as an admin role, employee, super admin, network administrator, security administrator, or others.

Users 405 may be associated with small business assets 402. Each asset 402 may have a well-defined ownership to a specific user. This ownership may represent a user who has primary responsibility for the asset. In some cases, more than one user may have access to an asset, and thus more than one user may be associated with the asset. For purposes of final responsibility, each asset may have an assigned owner who has overall responsibility for that asset. A user 405 may own multiple assets. In selected embodiments, each asset has a single ultimate owner. The term asset, as used herein, may encompass anything in the small business that needs to be tracked and/or protected.

Certain protection capabilities 410 may be mapped to individual assets 402. These capabilities may manage the detection, prevention, and remediation of threats to those individual assets. For example, protection capabilities 410 may include, by way of illustrative and nonlimiting example, antivirus, virtual private networks (VPN), online or web protection, social media protection, hardened password managers, online transaction protections, privacy monitors or managers, and others.

At least some assets 402 may have associated therewith a monitoring mechanism, which may be associated with a monitoring agent. Monitoring mechanisms for small business assets may be provided to monitor security events, provide security state and configuration, and provide streams to a small business protection cloud service. Thus, monitoring agent 404 may also provide a monitor streaming mechanism to stream security events to the cloud service. These events may be consumed by various subsystems, such as health assessment 420, policy engine 424, alerts framework 428, or others. These events may trigger certain business logic within the specific subsystems to provide specified outcomes.

A security management cloud service 440 may include various components to carry out its specified functions.

For example, a health assessment subsystem 420 may be provided. This subsystem represents the overall security posture of a small business by means of a health assessment score. This score may be representative of all protection vectors across all the assets of the organization that impact the security posture of the organization. A policy engine 424 may provide a policy framework. This may include a framework to define policies and evaluate policies for compliance with an enterprise-specified compliance regimen or policy.

An alerts engine 428 may receive alerts, such as streamed events from monitoring agent 404.

A security management orchestrator 448 may also be provided. Event hub 412 may aggregate event notifications and other notifications for consumption by orchestrator 448. Orchestrator 448 orchestrates the overall security management system. It may use an actions framework 432 to generate automated or semiautomated actions to improve the security posture of the small business. Actions 432 may be pushed out to an actions framework 416. It may also remediate any security threats, take preventive measures, provide recommendations, and provide alerts.

Security actions framework 416 may provide the mechanism to create, communicate, and automate security actions. An action agent 408 on asset 402 may then be provided to carry out the actions.

An administrative console 442 may be provided for use by an administrator of the security services provider. Admin console 442 may provide a user experience or user interface, including a status, reports, alerts, and actions. Admin console 442 provides a mechanism for an administrator of the security services provider to have an overall view of ecosystem 400 and to perform necessary actions.

Ecosystem 400 may achieve the simplicity that small businesses may prefer for managing business security. To this end, ecosystem 400 provides discovery and visibility of assets that matter to the small business. The system may also determine the security posture and determine what may improve the posture. Ecosystem 400 may also provide recommended actions 432 and action agent 408 that can carry out the actions.

Experience and expertise may be necessary to understand and interpret the telemetry data received from various assets 402. This expertise may determine who or what is vulnerable, why certain entities are vulnerable, the proper security settings for an enterprise, which product configurations are preferable in a particular context, and which user behaviors may be considered risky or dangerous. Understanding, interpreting, and correlating security events may be a complex task that requires high levels of expertise. Some of the complexity includes determining how to control and manage security. This management may include determining what to control, what to change, and when to change it. These decisions may rely on expertise that some small businesses lack.

Ecosystem 400 provides a user centric perspective rather than a device centric perspective. The system achieves user centricity via various mechanisms.

Ecosystem 400 may expand security management to security, privacy, and identity management. Thus, the threat surface of a user may go beyond an individual device. As a consequence, ecosystem 400 may provide an expansive view that goes beyond only devices and includes a plurality of assets that matter to the users and employees of a small business. Digital assets may include, by way of illustrative example:
Identities such as email address, federated IDs, and others
Other identities, such as tax IDs, driver's licenses, and other credentials
Social media profiles and posts
Online services, including financial and e-commerce
Other online accounts
Data, including local and cloud storage, emails, chats, blogs, and others
Devices, device environments, applications, and others
Network devices
Other communications including IM, chat, and others
Interactions, including interactions with online services and transactions.

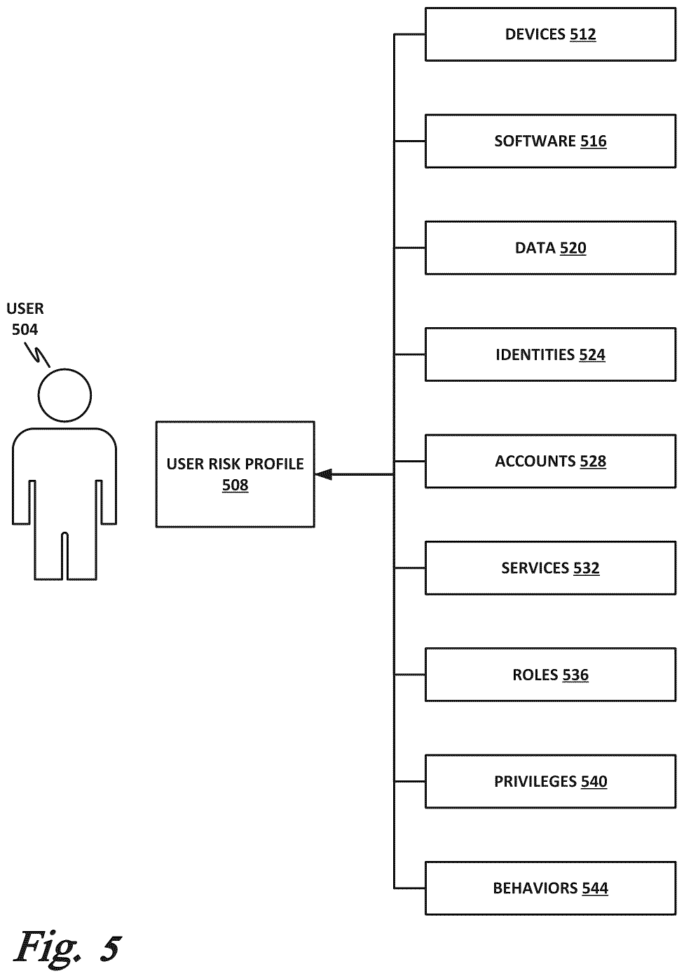

FIG. 5 illustrates another dimension of a risk assessment ecosystem, including a user risk profile 508. User risk profile 508 is another mechanism by which the risk assessment ecosystem may realize user centricity. User risk profile 508 may be associated with an individual user 504. User risk profile 508 may be computed based on the security state of various owned assets and user behaviors. It may also depend on the user's role and privileges and data that the user has access to. These may include employee data, sales data, privileges access, HR or sales systems, and social media assets. Thus, as illustrated in FIG. 5, user risk profile 508 may account for various factors such as devices 512, software 516, data 520, identities 524, accounts 528, services 532, roles 536, privileges 540, and behaviors 544, by way of illustrative and nonlimiting example.

User behavior may also play an important role in managing security and providing user centricity. Specific user behaviors that are high risk may be detrimental to the overall security of small business assets.

A user risk profile may be computed as a weighted sum of factors, including role sensitivity, asset ownership, and user behavior risk.

Role sensitivity, in one illustrative example, is a numeric score from 1 to 5. 5 is high where the role of the user needs to have access to more resources and data. A score of 1 is lower wherein the user has access to fewer resources and data. In an example, this number may be determined by having a human administrator familiar with the business rate the sensitivity of the user's role. Alternatively, the system may assign default values that can change over time.

Asset ownership may also be of value from 1 to 5. 5 is high and indicates that the user owns a large number of assets relative to the rest of the population of the small business. In one illustration, this may be expressed using bands of percentiles of assets owned of the organization, for example, with 5 representing the 90th percentile of asset ownership.

User behavior risk may also be a numeric value from 1 to 5, with 5 being the most high-risk behavior. Behavior risk may be constantly assessed and reassessed based on historical behaviors that are deemed risky. Behavior risk may be dependent on a specific security event encountered by a user. For example, if a user has a malware infection, visit malicious URLs, visit suspicious URLs, subscribes to low privacy services, or disregards warnings from security software, the user's behavior risk may be increased.

UserRiskProfile=(w1*RoleSensitivity+w2*AssetOwnership+w3*UserBehaviorRisk) Mathematically:

In this formula, W1, W2, and W3 may be values between 0 and 1 and together may add up to 1. The weights themselves may be changed based on either administrator input or security expert input.

With user risk profiles assigned, users may be grouped based on a risk profile of the users. The risk factor may be propagated down to every asset owned by the user.

The risk assessment ecosystem provided herein recognizes that a business IT environment is complex even for a small business. Thus, the ecosystem may provide a system to simplify the representation of the overall security state of assets. These may be encapsulated into an overall health score.

The health score may be derived from a security state/configuration, specific security events, and/or behaviors of the stakeholders (i.e., users).

The health assessment score may be derived from various vectors. It may be expressed as a simple explainable score. Specific recommendations that can be implemented to improve the health score may also be provided to the small business. This simplifies the model for the small business administrator to understand the security state of all the business' assets.

In one example, the user health score may be represented by the following equation for each category:

$$\frac{{\sum }_{asseti = 1}^{n} \{ {v}_{i} \times [ {\sum }_{protectionj = 1}^{m} ( {ws}_{ij} \cdot {state}_{ij} ) ] \}}{{\sum }_{asseti = 1}^{n} \{ {v}_{i} \times [ {\sum }_{protectionj = 1}^{m} ( {ws}_{ij} ) ] \}}$$

Within a category:
n is the total number of user assets with a list of M protections possible for asset I
vᵢ represents a notional value of asset I. This value can be changed by the administrator or may be learned gradually to reflect the changing monetary or security importance of the asset to the company. The higher the asset's value, the higher the importance that may be associated with the asset. These values may be periodically reassessed by the administrator based on changing access patterns. The value may correspond to multiple levels such as 1.0, 1.1, 1.3, 1.5. Alternatively, arbitrary values may be assigned.
wsᵢⱼ is the weight of protection vector J for asset I. These weights may be proportional to an impact on the user's security, privacy, identity, and trust. Illustrative values may include 100 for critical, 60 for high, and 30 for medium. These weights may be preconfigured or changed by an expert administrator. The vector weights may be automatically learned over time, set by the administrator based on the nature of the business, as gathered by an individual assessment questionnaire, or periodically assessed by the administrator.
stateᵢⱼ is 1 or 0 based on whether the specific protection J for an asset has been turned on or off. Each protection may be available as a feature and may be turned on by a user.

The numerator of the above equation is labeled acquired_score whereas the denominator is labeled max_score.

Regardless of the number of assets a user possesses or their values or the weights of a protection vector, the score for a category may be mathematically defined to be between 0 and 1. In other words, the score may not be an unbounded number and will not be a negative number.

Multiple category scores may be combined in the following way to generate an overall user health score.

$${Score}_{Total} = {M}_{f} \times {\sum }_{i = 1}^{n} weig {ht}_{i} \times \frac{{acquired\_score}_{i}}{{max\_score}_{i}}$$

In this case, weightᵢ (adjustable) corresponds to the weight across a category. Again, each weight may be a value between 0 and 1, and the weights may add up to 1.0. By way of illustration, security may have a weight of 0.6, identity may have a weight of 0.4, and privacy may have a weight of 0.1. All of the weights across the categories should add up to 1.0, i.e.:

$$1 = {\sum }_{i = 1}^{n} {weight}_{i}$$

Acquired score and max score are as described previously. The small business administrator may determine which of these categories is most important and may balance their weights.

M_{f} may be an internal “fudge” factor that may be always less than 1. This fudge factor may indicate the reality that protection is never perfect and thus the score may be adjusted to reflect this imperfection.

In some embodiments, user groups are an important aspect of small business security. Using the principles described above, it is possible to compute scores for arbitrary groups of users that are dynamically created by the administrator. A group may include assets that belong to individuals, individual user assets, and vectors. These may be combined into a group health score according to an equation that is similar to the user score:

$${Score}_{Group} = \frac{{\sum }_{asseti = 1}^{n} \{ {v}_{i} \times [ {\sum }_{protectionj = 1}^{m} ( {ws}_{ij} \cdot {state}_{ij} ) ] \}}{{\sum }_{asseti = 1}^{n} \{ {v}_{i} \times [ {\sum }_{protectionj = 1}^{m} ( {ws}_{ij} ) ] \}}$$

A difference between the user health score and group health score is that, for the latter, all assets belonging to users in the group are scored. The terms in this equation are the same as those described previously.

As with individuals, the same with groups, category scores can be computed across security, privacy, and identity. The same constraints about the weights are applicable to the group score.

An organization health score may be similarly calculated across all assets of the organization. An organization-wide category score can also be created.

Thus, health scores can be computed across multiple levels. They may be computed across user assets owned by individual employees, a group of employees, and for the overall organization. Beyond the organization, the score of a group of companies that have similar security profiles, business types, or other classifications like regional location, may also be computed. These scores may provide a holistic score across all dimensions or may be a specific score for security, identity, and/or privacy.

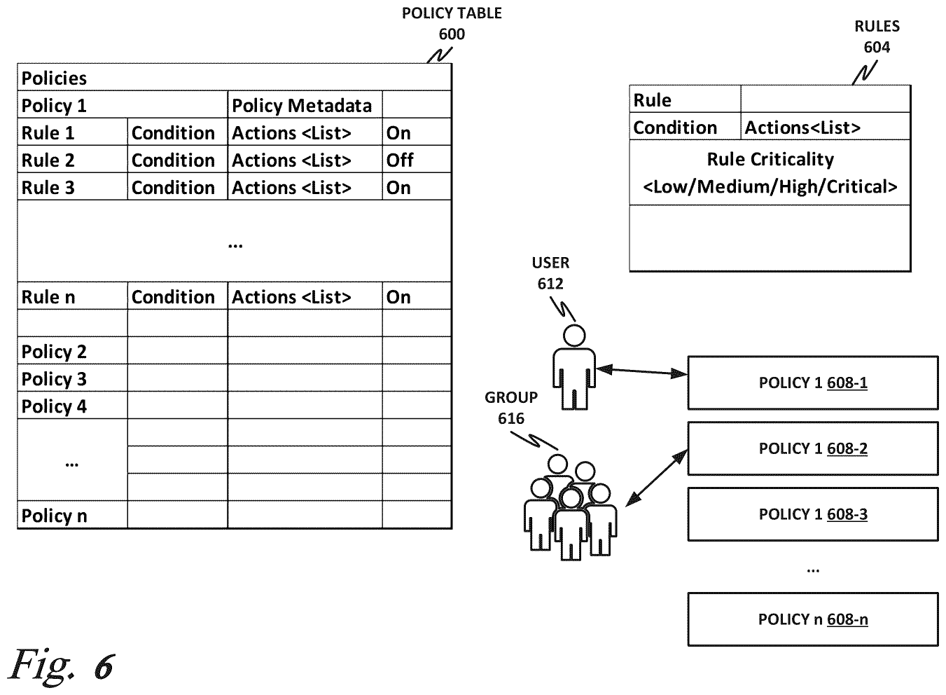

FIG. 6 is a block diagram representation of selected aspects of security state management. Security state management may be encapsulated into a policy that dictates the compliance required to keep assets secure. A policy may consist of a set of rules. Each rule may include an expected state that triggers the rule, a designation of what constitutes a violation and an optional severity of the violation, and a specification of actions to take to make an asset compliant with the policy.

A policy engine may process all security events to assess the compliance to the applied policies and automatically generate required actions to be executed to make the asset compliant to the policy.

A policy table 600 is provided by way of illustration. This policy table should be understood to be an illustrative and nonlimiting example of how a policy table may be structured. In this example, policy table 600 includes an array of policies labeled policy 1 through policy N. Each policy may include a group of rules labeled rule 1 through rule N. These rules are active for the policy or may optionally be inactivated by turning them off, as in the rightmost column. Each rule may also include a list of actions to be taken if a condition is true. A rule may also include a condition based on a specific state of a user or an asset. When the condition is found to be true, a list of actions may be applied and may be performed by an action agent on the asset. Some rules may also have an optional criticality value. As illustrated in rule 604, rules may have an optional criticality value. The criticality value may signify the importance of the rule to the overall security state of the asset and/or user. This may signify the importance of the rule to the overall security state of the asset and/or the user.

A user 612 or a group of users 616 may be assigned to various policies. For example, user 612 may be assigned policy 1 608-1, group 616 may be assigned to policy 2 608-2. Additional policies, such as policy 3 608-3 through policy N 608-N may be assigned to various users and/or groups of users.

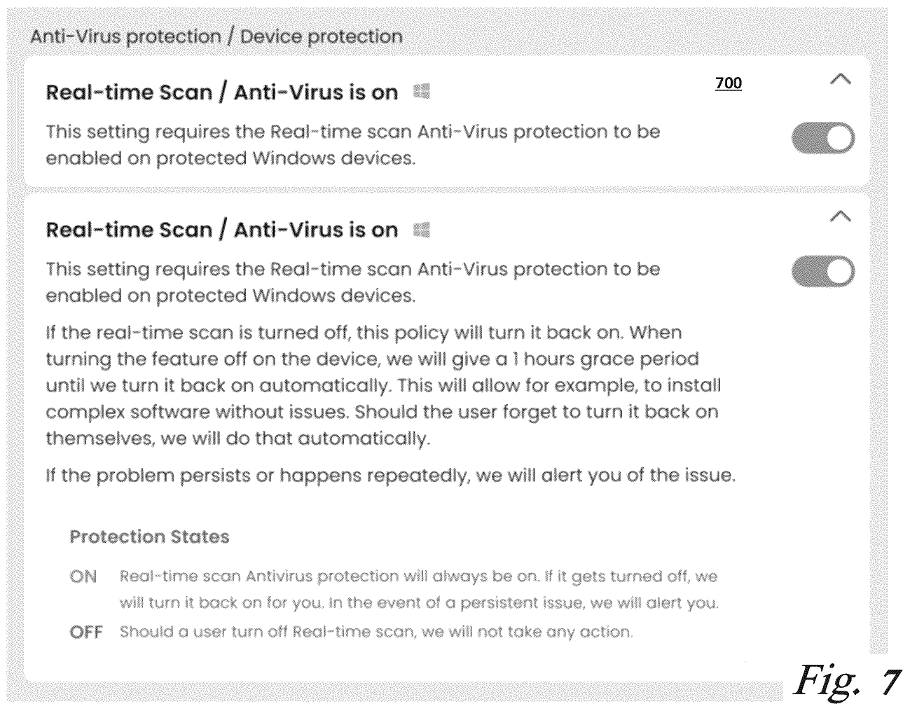

FIG. 7 is a block diagram illustration of an illustrative user interface elements 700. UI elements 700 is a dashboard that may be displayed to a user to indicate a device protection status. In this case, the user has enabled real-time scan and antivirus. The interface also indicates that, if real-time scan is turned off, a policy applicable to the small business will turn it back on. In this case, a user is given a one-hour grace to perform any necessary work before real-time protection is turned back on. This may be useful, for example, in the case of complex software that requires antivirus protection to be disabled before it can be installed. Good practice is that the user would turn antivirus off temporarily to install such software and then turn it back on. However, if the user forgets, the policy indicates that real-time scanning in antivirus should be turned back on automatically to protect the user and the business.

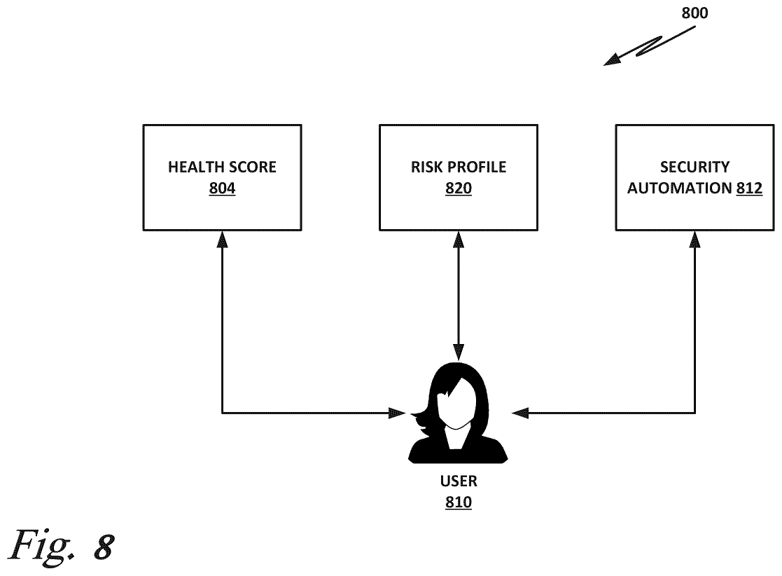

FIG. 8 is a block diagram illustration of selected elements of a user protection ecosystem. User protection ecosystem 800 operates with a user 810 and provides both a health score 804 and security automation 812, such as the security automation illustrated in the previous FIG. 7.

A small business administrator may customize a policy automatically based on a risk profile. Users, such as user 810, may be divided into risk groups with automated policy customizations for each risk group. Each user or group may be assigned a policy as applicable to the whole company or a specific policy for different groups. A baseline policy may be customized to a specific user based on the user's risk profile 820.

Mechanisms to customize policy may be available. A policy may include a set of rules with some rules active and others optionally inactive. The mechanism to customize may provide a user interface or other elements to the small business security administrator. This mechanism may automatically make certain rules active for certain users based on risk profile 820 and the criticality of the rule.

For users with high-risk profiles, even rules with lower criticality may be made active. For example, the following table illustrates how a policy may be customized for a specific user based on the user's risk profile 820. In this table, “default” implies that the rule has some state as in the base policy. For example, if the rule is “active” in the base policy, it remains active for the user. If the rule is off in the base profile, it may remain off for this user. “Active” in the table implies that the default state of the rule is overridden for this user. In this case, the rule is always active for the user, regardless of the default state.

| Rule Criticality → | Low | Medium | High | Critical |
|---|---|---|---|---|
| User Risk Profile - 1 | Default | Default | Default | Active |
| User Risk Profile - 2 | Default | Default | Default | Active |
| User Risk Profile - 3 | Default | Default | Active | Active |
| User Risk Profile - 4 | Default | Active | Active | Active |
| User Risk Profile - 5 | Default | Active | Active | Active |

The outcome of executing a policy may include a list of actions that are automatically executed to ensure that the security state of all assets are compliant to the designated policy. Illustrative classes of actions may include:
Inform—information to a specific user or group or an admin
Advise—security advised three specific user group or administrator
Inform and act—inform the admin and enforce. Since the action is critical for the security posture and/or the platform, such automation may be appropriate
Seek permission and act—ask the admin for consent or permission before acting as above
Act and inform—the action is sufficiently critical that it is automated, and the admin is informed only after the action is taken. This may be appropriate for a case where the system cannot wait for the admin to see the alert and act on it.

Actions may be prioritized based on the context, target user risk profile, and/or expected outcome. For example, outcomes may include health score improvement, preventive measures, or user education. Examples of different actions and classifications include:

| | Security | |
|---|---|---|
| Action | Impact | Action type classification |
| Enable On | Critical | Act and inform |
| Access | | |
| Malware scan | | |
| Enable Wi-Fi | Medium | Advise |
| security | | |
| Update OS | Medium | Inform and Act |
| Use VPN | Medium | Advise |

A dispatch framework may be provided in software to send the actions to users and assets. The dispatch framework may decide which actions are to be sent to which destinations and when. These decisions may depend on the priority of the actions and the type of actions being taken. For example, an informed type action may be targeted to a user and sent to a device where the user is active. Alternatively, the action may be sent to the device at a time when the user is most likely to be active or likely to respond. In the case of an act and informed type action, the action may be sent immediately to the asset that the action is targeted to, and the asset's action agent is expected to complete the action before information is sent to the user.

The system and methods provided here provide necessary monitoring, visibility, manageability, control, and end-to-end automation for small businesses. These may help the small business to take remedial and preventive actions to secure the IT infrastructure. Small businesses may lack the experts on hand to understand and manage complexity. Therefore, this system provides methods to abstract the controls into a health score, alerts, and automation through a simple console application. This may be provided in a web portal. In this system, the users understand security risks at a glance and may act on remediation with informed clicks. This simplicity is provided even though the system employs complex methods for monitoring and remediation.

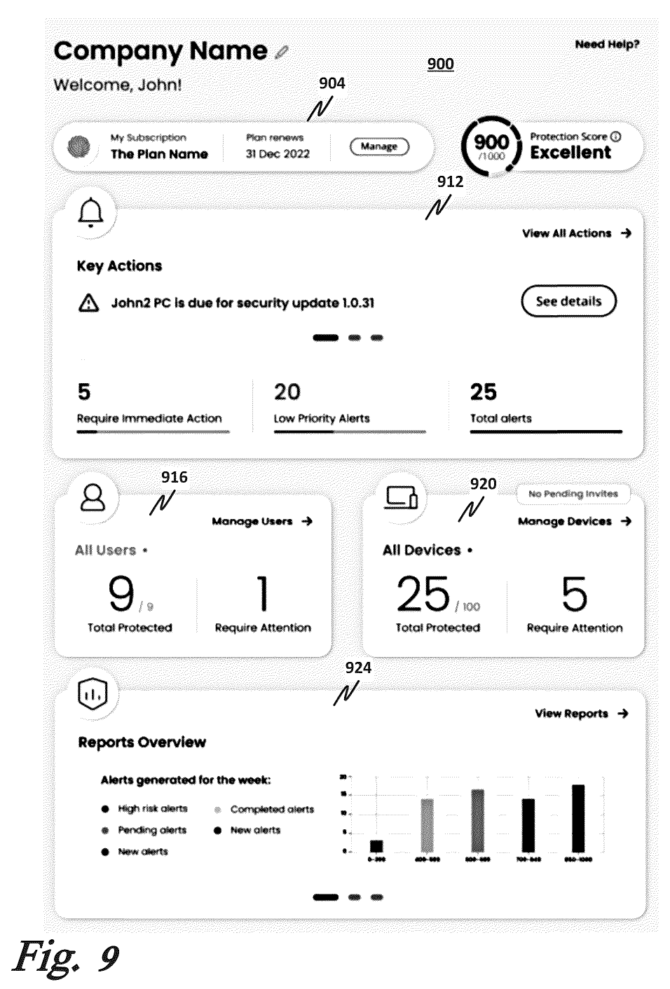

FIGS. 9, 10 and 11 provide illustrative UI elements that may be provided in a security ecosystem.

FIG. 9 illustrates a dashboard 900 that is provided to a user named John. John may be a small business owner or a person in charge of security for a small business. In this case, the dashboard provides a plan status 904 that informs John of the current plan and when it will be renewed. An enterprise health score 908 provides an overall health score for the enterprise. In this case, the enterprise is scored 900 out of 1,000 points. This may be scaled based on the raw health score to provide a useful metric for the small business. In this case, the health score also includes an enumerated score category such as “excellent.” Color coding may also be used, such as green for excellent, yellow for fair, orange for poor, or red for critically low.

A key actions dashboard 912 may indicate key actions that may need to be taken. For example, John may have a second PC called John 2 PC that is due for a security update to version 1.0.31 of a particular piece of software. User John can click on the see details button to see additional details about this alert. John is also informed that there are five actions that require immediate action and 20 low priority alerts. This provides 25 total alerts. User John can click on the button, view all actions to see all available actions and what needs to happen for each one.

A user dashboard 916 indicates that there are nine managed users for this enterprise and, of those, one requires attention.

A device dashboard 920 indicates that there are 25 total devices for the enterprise with five that require attention.

Finally, a reports overview 924 may provide graphs and reports that may provide easily digestible information for user John.

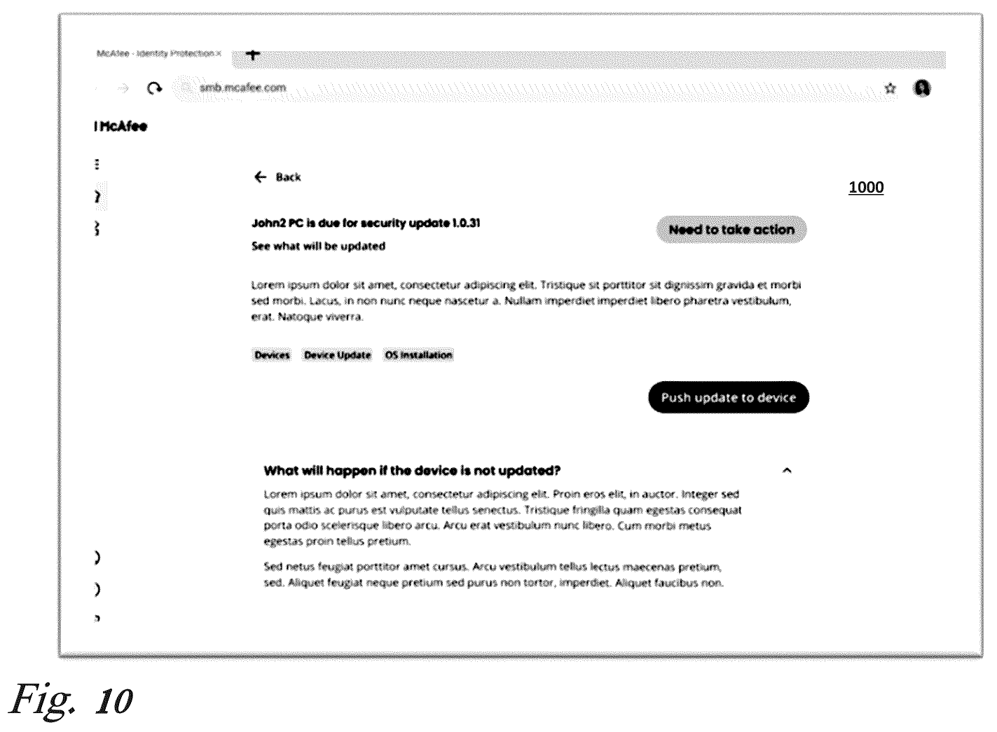

FIG. 10 is a block diagram illustration of a UI element 1000, which provides a detail view, such as may be reached when user John clicks on the button see details on key actions dashboard 912.

In this case, John is provided with details for the security notification that John 2 PC is due for a security update to 1.0.31. The dashboard detail view may inform John of what updates will be applied and what will take place if John uses the button to push the update to the device as illustrated. This view may also include a box to tell John what will happen if the device is not updated. This may warn John of security implications of not taking the action. In some cases, John may have a cogent reason for not taking the action and thus may elect not to push the update to the device. This detail view will help John to make an informed decision about whether to go ahead and push the update or to stay on the current version and may help John understand the risks and rewards of each action.

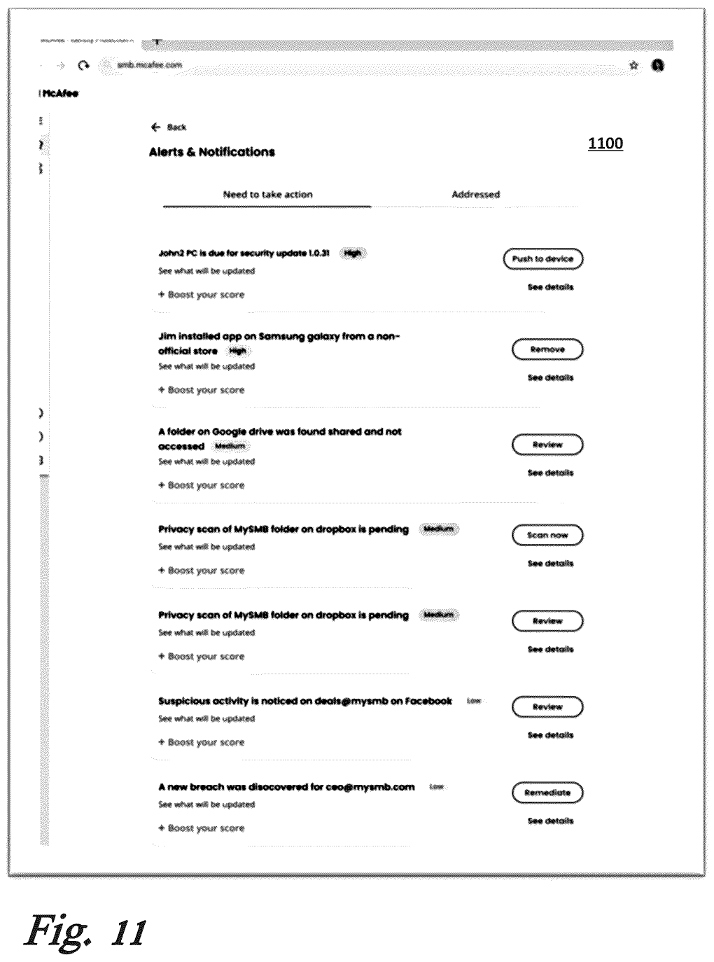

FIG. 11 is a UI element 1100 that illustrates a view that user John might see if he clicks on view all actions in key actions dashboard 912. In this case, John is given a list of available alerts and notifications. Each individual item may have a short description such as “John 2 PC is due for security update 1.0.31” along with an indication of the severity, which in this case is high. The dashboard may also provide a simple button to push the update to the device. Another alert is “Jim installed app on Samsung Galaxy from a non-official store”. This has a high security alert as well. In this case, user John has a simple button that can be used to remove the app from Jim's Samsung Galaxy device. This would remotely instruct the action agent on Jim's Samsung Galaxy device to remove the unapproved application.

A medium level notification is “a folder on Google Drive was found shared and not accessed.” In this case, user Jim has a simple button to review the folder and available options.

A medium security risk also includes “Privacy scan of MySMB Folder on Dropbox is pending.” In this case, a scan is scheduled but has not yet been carried out. In that case, a simple button may allow user John to “scan now.”

A low-risk security notification is “suspicious activity is noticed on deals@MySMB on Facebook.” In this case, user John may have a simple button to review the alert and actions are available.

Another low severity notification is “a new breach was discovered for ceo@MySMB.com.” In this case, John has a simple remediate button which will carry out remedial action to remediate the breach.

In each instance, the user also has an interface to “see details” so that the user can see additional details about the security notice and also has an indication that addressing the issue will “boost your score.” Finally, the user may also have a button that indicates “see what will be updated.” This may provide an interface where the user can see which specific actions will be taken to remediate the security alert.

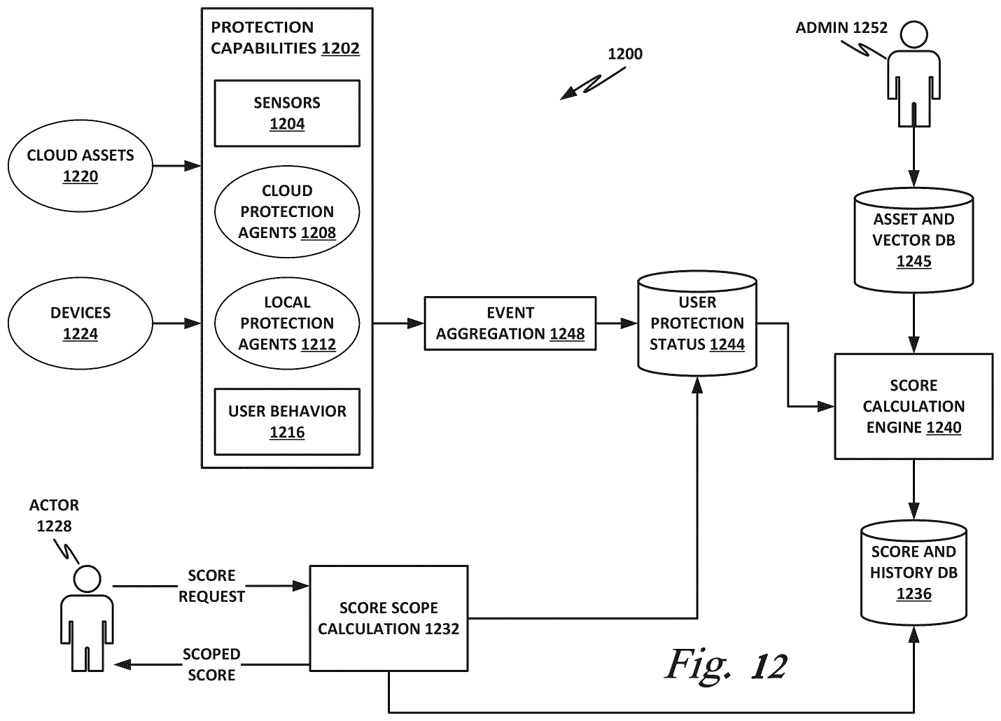

FIG. 12 is a block diagram representation of selected elements of a system 1200. System 1200 represents an additional embodiment of the small business ecosystem illustrated herein. System 1200 provides an additional embodiment wherein certain adjustments and modifications to the computation of risk assessment scores are made. System 1200 may be desirable because the complexity of protection may rise with the number of employees working from home or using a variety of personal devices for business purposes. As above, the small business may need to protect not just devices, but also any business assets including business employee accounts and business data shared on third-party platforms. Thus, a small business security solution may incorporate both efficient and effective protections to help ease administration from an end-user perspective.

This embodiment may equip the small business administrator with a meter to gauge organizational security health. With this meter, the administrator can quickly visualize how healthy the organization's protection is. This metric may be based, in part, on the elements of a comprehensive business threat surface. It may also include a characterization of significant business threat vectors. The metric may also be aided by defining mechanisms to assess the personal protection threat state of users and devices. The metric may also be aided by defining a method to quantify protection across the entire personal protection threat surface.

System 1200 may help to enable small business administrators to have a ready and visible idea of the organization's protection health, thus requiring action only when the score dips below a certain level.

As users increasingly BYOD and use their own devices for work, along with shared business resources, it may be desirable to offer personal and business scores within a single company. When the score is personal, the issue of privacy may be of higher importance. Thus, it may be desirable to offer a score that considers both role and privacy aspects for users individually and across the business.

In some cases, protection of personal data and personal devices may be offered by the small business employer to employees as a value-added extra. This may represent a fringe benefit associated with working for the business. Thus, while providing a nonbusiness user privacy health score may not impact business operations directly, it may be valuable for employee retention and recruitment and employee satisfaction.

Adjustments to the health score ecosystem may include an ability for an administrator to personalize the organization's score, such as by changing asset values or specific vector weights that are unique to that organization. Asset values and vector weights may initially be assigned by the security services administrator, but it may be valuable for the small business administrator to make adjustments that are specific to the enterprise. An additional adjustment may include allowing multiple views of the business score within the same organization. These may include an overall organization-specific business score, as well as a group score and a privacy and role-scoped individual user score.

In some of the preceding embodiments, the value of assets may be determined by a security solutions provider, such as McAfee, Inc. These asset values may be designated according to asset classes. This and other embodiments further provide an ability for an administrator to change individual asset values based on their importance to the individual company.

In preceding embodiments, the weights of individual vectors may be determined to be high, medium, or low based on impact. This and other embodiments may enable an administrator to change weights based on the expertise of an administrator. The administrator may change even individual vector weights per organizational importance. It may also be possible to nudge a user towards a higher vector value depending on specific malware campaigns which can later be readjusted as necessary.

This embodiment may also provide an automatic mode wherein learning from admin and user behavior may lead to suggestions for value and weight changes for a user, group, or organization.

Preceding embodiments may also include category values determined by the security solutions provider. This and other embodiments may also add the possibility of an administrator specifying category values for an organization. For example, company A may give the security category a higher value, such as from 0.6 to 0.8, while reducing the category values for identity (e.g., 0.3 to 0.15) or privacy (e.g., 0.1 to 0.05).

This embodiment may also provide the ability to score categories (e.g., good, fair, excellent) to different score levels for specific users. For one user, it might be acceptable to have a “good” security score, while other users may need to have a higher category score to be acceptable to the organization. For example, an intern with limited access to business-critical data and proprietary data, and with limited scope of duties, may have a fair security posture, and this may be deemed acceptable for the organization. However, the small business CEO or CFO may need to have an excellent security posture to meet policy for the small business.

User scores may also involve individual user accounts that are shared between personal and business users. In this embodiment, the administrator may get a business score and view only alerts that need action. It may also be possible for a user score to not be shared with the administrator. This may lead to a score that maintains individual user privacy while ensuring that the user remains security compliant. Thus, in some cases, the user may have a personal security posture as well as a business security posture. For example, as illustrated in FIG. 3, a user device 300 may include both personal data 320 and business data 328. User device 300 may also include personal applications 316 and business applications 324. Small business agent 312 may provide a business score to the user based on the user's security posture as it relates to business data 328 and business applications 324. This score may be shared with the business security administrator as it impacts the business directly. However, as a value-added extra, small business agent 312 may also provide an individual score for personal applications 316 and personal data 320. Optionally, this personal user score may score privacy higher than security relative to the business security score. The individual user may be more concerned about preserving privacy. This personal security score may not be shared with the business administrator but may be displayed to the individual user on a personal dashboard with attendant recommendations for maintaining personal security. This may be a value-added extra that helps the users maintain both business and personal security and provides security protection, including a degree of privacy for the individual from the business.

This embodiment provides advantages including combining non-device asset classes with devices for a score. This solution also provides the ability to dynamically change or assess asset value or vector values. Further advantageously, this system may provide a twofold score. The score includes an individual user in a business with a mix of personal and shared assets, as well as a protection score across entire business. The system may also advantageously provide privacy and scope-compliant scores.

In this embodiment, two different scores may be displayed for users while maintaining individual user privacy with respect to the business or enterprise. Thus, for example, individual users may not be shown the entire business score because that may be outside the scope of their responsibilities. On the other hand, business security administrators may not be shown individual scores because this may violate user privacy.

This embodiment also allows an organization to set its own importance for assets, categories, and protection vectors as necessary. This may result in an organization-specific protection score that is unique to that particular enterprise. This may give the administrator more control.

This embodiment makes it possible to offer a combined personal and business protection solution. Personal protection can be provided as a perk or value-added extra, with scores and assets being solely personal. Business protection may be considered for shared or business assets.

A business IT environment may be complex even for a small business. This embodiment simplifies a representation of the overall security state of all assets that may be encapsulated into a health score for either the business or an individual user. As illustrated in FIG. 12, the health score may be derived from a security state or configuration that includes asset values and vector values. It may also include specific security events and behaviors of the stakeholders.

In this example, the individual user may be actor 1228, who may be interested in a score scope calculation 1232. Thus, actor 1228 may request, via a device such as a mobile device, tablet, laptop, desktop, or other computer, a score scope calculation 1232. This score request may result in a scope score provided to actor 1228. This score may include a personal score that is not shared with business administrator 1252 and that is only displayed to actor 1228. However, the mobile device may also calculate a business scope score that is shared with admin 1252. Admin 1252 may have access to an asset and vector database 1245, which may allow admin 1252 to adjust certain attributes of the calculation according to the needs of a specific business. These are provided to a score calculation engine 1240, which performs the actual computation. Score calculation engine 1240 may store business scores in a score and history database 1236. However, the individual or personal user score for actor 1228 may be stored locally on the user's device and may not be exported to an enterprise scope score and history database 1236.

The score may include protection capabilities 1202 for cloud assets 1220 and devices 1224. Protection capabilities 1202 may include sensors 1204, cloud protection agents 1208, local protection agents 1212, and user behaviors 1216. As in prior embodiments, these protection factors may result in protection events or triggers, which may be aggregated via event aggregation 1248. Event aggregation 1248 may be an input to a user protection status 1244, which may also consider the personal and/or business score of actor 1228. These inputs may ultimately be used to provide score calculation engine 1240.

In this embodiment, the user health score may be as calculated above, including the same variables as described above.

$$\frac{{\sum }_{asseti = 1}^{n} \{ {v}_{i} \times [ {\sum }_{protectionj = 1}^{m} ( {ws}_{ij} \cdot {state}_{ij} ) ] \}}{{\sum }_{asseti = 1}^{n} \{ {v}_{i} \times [ {\sum }_{protectionj = 1}^{m} ( {ws}_{ij} ) ] \}}$$

One difference in this embodiment is that individual vector weights wsᵢⱼ and notional asset values vᵢ may optionally be controlled by an administrator of the small business. The assets considered for a user may also include a mix of private, shared, and business-allocated assets. For a user individual or personal privacy score, all of these assets may be considered. For a business score, only business or business-adjacent assets may be considered. Regardless of the number of assets a user possesses or their values of weights of a protection vector, the score for a category may be mathematically defined to be between 0 and 1 as before. As before, the value will not be an unbounded number and will not be negative.

Similarly, a total score may be calculated as above.

$${Score}_{Total} = {M}_{f} \times {\sum }_{i = 1}^{n} weig {ht}_{i} \times \frac{{acquired\_score}_{i}}{{max\_score}_{i}}$$

A modification in this embodiment may include that the category weightᵢ may be changed by the administrator.

Furthermore, a group score may be calculated as above.

$${Score}_{Group} = \frac{{\sum }_{asseti = 1}^{n} \{ {v}_{i} \times [ {\sum }_{protectionj = 1}^{m} ( {ws}_{ij} \cdot {state}_{ij} ) ] \}}{{\sum }_{asseti = 1}^{n} \{ {v}_{i} \times [ {\sum }_{protectionj = 1}^{m} ( {ws}_{ij} ) ] \}}$$

In this embodiment, the assets considered for a user may include a mix of private, shared, and business-allocated assets. The business score may measure protection across shared and business-allocated assets. However, in that case, the assets may not be deemed private by the user. If assets are deemed private, then those private assets may be excluded from the group score.

FIG. 13 is a block diagram of a hardware platform 1300. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 1300, even though they may be scattered across a data center, or even located in different data centers.

Hardware platform 1300 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 1300 is arranged in a point-to-point (PtP) configuration. This PtP configuration is popular for personal computer (PC) and server-type devices, although it is not so limited, and any other bus type may be used.

Hardware platform 1300 is an example of a platform that may be used to implement embodiments of the teachings of this specification. For example, instructions could be stored in storage 1350. Instructions could also be transmitted to the hardware platform in an ethereal form, such as via a network interface, or retrieved from another source via any suitable interconnect. Once received (from any source), the instructions may be loaded into memory 1304, and may then be executed by one or more processor 1302 to provide elements such as an operating system 1306, operational agents 1308, or data 1312.

Hardware platform 1300 may include several processors 1302. For simplicity and clarity, only processors PROC0 1302-1 and PROC1 1302-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 1302 may be any type of processor and may communicatively couple to chipset 1316 via, for example, PtP interfaces. Chipset 1316 may also exchange data with other elements, such as a high performance graphics adapter 1322. In alternative embodiments, any or all of the PtP links illustrated in FIG. 13 could be implemented as any type of bus, or other configuration rather than a PtP link. In various embodiments, chipset 1316 may reside on the same die or package as a processor 1302 or on one or more different dies or packages. Each chipset may support any suitable number of processors 1302. A chipset 1316 (which may be a chipset, uncore, Northbridge, Southbridge, or other suitable logic and circuitry) may also include one or more controllers to couple other components to one or more central processor units (CPU).

Two memories, 1304-1 and 1304-2 are shown, connected to PROC0 1302-1 and PROC1 1302-2, respectively. As an example, each processor is shown connected to its memory in a direct memory access (DMA) configuration, though other memory architectures are possible, including ones in which memory 1304 communicates with a processor 1302 via a bus. For example, some memories may be connected via a system bus, or in a data center, memory may be accessible in a remote DMA (RDMA) configuration.

Memory 1304 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 1304 may be used for short, medium, and/or long-term storage. Memory 1304 may store any suitable data or information utilized by platform logic. In some embodiments, memory 1304 may also comprise storage for instructions that may be executed by the cores of processors 1302 or other processing elements (e.g., logic resident on chipsets 1316) to provide functionality.

In certain embodiments, memory 1304 may comprise a relatively low-latency volatile main memory, while storage 1350 may comprise a relatively higher-latency nonvolatile memory. However, memory 1304 and storage 1350 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 1304 and storage 1350, for example, in a single physical memory device, and in other cases, memory 1304 and/or storage 1350 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 1322 may be configured to provide a human-readable visual output, such as a command-line interface (CLI) or graphical desktop such as Microsoft Windows, Apple OSX desktop, or a Unix/Linux X Window System-based desktop. Graphics adapter 1322 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 1322 may include a hardware graphics card, which may have its own memory and its own graphics processing unit (GPU).

Chipset 1316 may be in communication with a bus 1328 via an interface circuit. Bus 1328 may have one or more devices that communicate over it, such as a bus bridge 1332, I/O devices 1335, accelerators 1346, communication devices 1340, and a keyboard and/or mouse 1338, by way of nonlimiting example. In general terms, the elements of hardware platform 1300 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 1340 can broadly include any communication not covered by a network interface and the various I/O devices described herein. This may include, for example, various universal serial bus (USB), FireWire, Lightning, or other serial or parallel devices that provide communications.

I/O Devices 1335 may be configured to interface with any auxiliary device that connects to hardware platform 1300 but that is not necessarily a part of the core architecture of hardware platform 1300. A peripheral may be operable to provide extended functionality to hardware platform 1300, and may or may not be wholly dependent on hardware platform 1300. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 1342 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 1332 may be in communication with other devices such as a keyboard/mouse 1338 (or other input devices such as a touch screen, trackball, etc.), communication devices 1340 (such as modems, network interface devices, peripheral interfaces such as PCI or PCIe, or other types of communication devices that may communicate through a network), audio I/O 1342, a data storage device 1344, and/or accelerators 1346. In alternative embodiments, any portions of the bus architectures could be implemented with one or more PtP links.

Operating system 1306 may be, for example, Microsoft Windows, Linux, UNIX, Mac OS X, iOS, MS-DOS, or an embedded or real-time operating system (including embedded or real-time flavors of the foregoing). In some embodiments, a hardware platform 1300 may function as a host platform for one or more guest systems that invoke application (e.g., operational agents 1308).

Operational agents 1308 may include one or more computing engines that may include one or more nontransitory computer-readable mediums having stored thereon executable instructions operable to instruct a processor to provide operational functions. At an appropriate time, such as upon booting hardware platform 1300 or upon a command from operating system 1306 or a user or security administrator, a processor 1302 may retrieve a copy of the operational agent (or software portions thereof) from storage 1350 and load it into memory 1304. Processor 1302 may then iteratively execute the instructions of operational agents 1308 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 1300 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), VPN, intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 1300 may be virtualized, in particular the processor(s) and memory. For example, a virtualized environment may run on OS 1306, or OS 1306 could be replaced with a hypervisor or virtual machine manager. In this configuration, a virtual machine running on hardware platform 1300 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 13 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

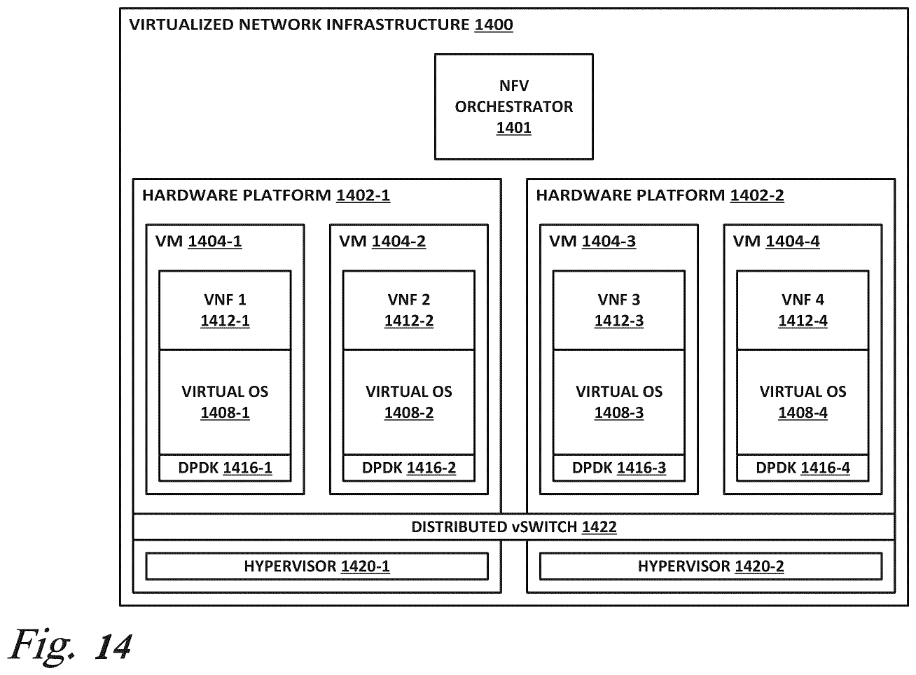

FIG. 14 is a block diagram of a NFV infrastructure 1400. NFV is an example of virtualization, and the virtualization infrastructure here can also be used to realize traditional VMs. Various features may be realized as VMs, including for example user desktops and endpoints. Furthermore, cloud or network services described herein may be realized as VMs.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1400. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 14, an NFV orchestrator 1401 may manage several VNFs 1412 running on an NFVI 1400. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1401 a valuable system resource. Note that NFV orchestrator 1401 may provide a browser-based or graphical configuration interface, and in some embodiments may be integrated with SDN orchestration functions.

Note that NFV orchestrator 1401 itself may be virtualized (rather than a special-purpose hardware appliance). NFV orchestrator 1401 may be integrated within an existing SDN system, wherein an operations support system (OSS) manages the SDN. This may interact with cloud resource management systems (e.g., OpenStack) to provide NFV orchestration. An NFVI 1400 may include the hardware, software, and other infrastructure to enable VNFs to run. This may include a hardware platform 1402 on which one or more VMs 1404 may run. For example, hardware platform 1402-1 in this example runs VMs 1404-1 and 1404-2. Hardware platform 1402-2 runs VMs 1404-3 and 1404-4. Each hardware platform 1402 may include a respective hypervisor 1420, virtual machine manager (VMM), or similar function, which may include and run on a native (bare metal) operating system, which may be minimal so as to consume very few resources. For example, hardware platform 1402-1 has hypervisor 1420-1, and hardware platform 1402-2 has hypervisor 1420-2.

Hardware platforms 1402 may be or comprise a rack or several racks of blade or slot servers (including, e.g., processors, memory, and storage), one or more data centers, other hardware resources distributed across one or more geographic locations, hardware switches, or network interfaces. An NFVI 1400 may also include the software architecture that enables hypervisors to run and be managed by NFV orchestrator 1401.

Running on NFVI 1400 are VMs 1404, each of which in this example is a VNF providing a virtual service appliance. Each VM 1404 in this example includes an instance of the Data Plane Development Kit (DPDK) 1416, a virtual operating system 1408, and an application providing the VNF 1412. For example, VM 1404-1 has virtual OS 1408-1, DPDK 1416-1, and VNF 1412-1. VM 1404-2 has virtual OS 1408-2, DPDK 1416-2, and VNF 1412-2. VM 1404-3 has virtual OS 1408-3, DPDK 1416-3, and VNF 1412-3. VM 1404-4 has virtual OS 1408-4, DPDK 1416-4, and VNF 1412-4.

Virtualized network functions could include, as nonlimiting and illustrative examples, firewalls, intrusion detection systems, load balancers, routers, session border controllers, DPI services, NAT modules, or call security association.

The illustration of FIG. 14 shows that a number of VNFs 1404 have been provisioned and exist within NFVI 1400. This FIGURE does not necessarily illustrate any relationship between the VNFs and the larger network, or the packet flows that NFVI 1400 may employ.

The illustrated DPDK instances 1416 provide a set of highly-optimized libraries for communicating across a virtual switch (vSwitch) 1422. Like VMs 1404, vSwitch 1422 is provisioned and allocated by a hypervisor 1420. The hypervisor uses a network interface to connect the hardware platform to the data center fabric (e.g., a host fabric interface (HFI)). This HFI may be shared by all VMs 1404 running on a hardware platform 1402. Thus, a vSwitch may be allocated to switch traffic between VMs 1404. The vSwitch may be a pure software vSwitch (e.g., a shared memory vSwitch), which may be optimized so that data are not moved between memory locations, but rather, the data may stay in one place, and pointers may be passed between VMs 1404 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1422 is illustrated, wherein vSwitch 1422 is shared between two or more physical hardware platforms 1402.

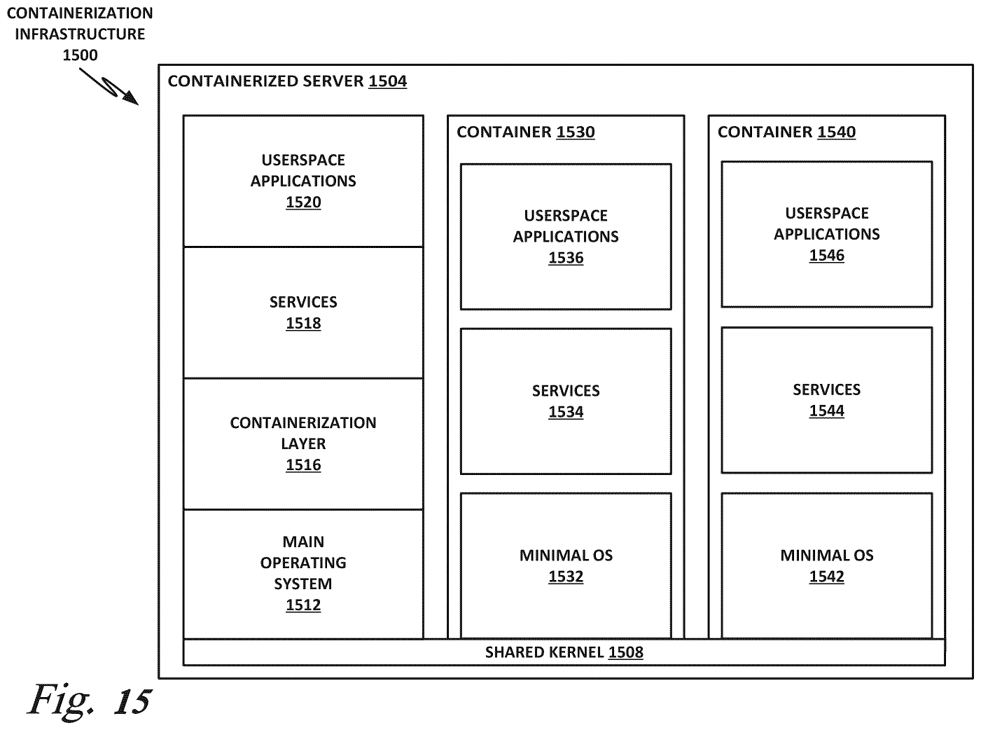

FIG. 15 is a block diagram of selected elements of a containerization infrastructure 1500. Like virtualization, containerization is a popular form of providing a guest infrastructure. Various services and microservices disclosed herein may be realized as containers, including cloud-based or network services.

Containerization infrastructure 1500 runs on a hardware platform such as containerized server 1504. Containerized server 1504 may provide processors, memory, one or more network interfaces, accelerators, and/or other hardware resources.

Running on containerized server 1504 is a shared kernel 1508. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1508 is main operating system 1512. Commonly, main operating system 1512 is a Unix or Linux-based operating system, although containerization infrastructure is also available for other types of systems, including Microsoft Windows systems and Macintosh systems. Running on top of main operating system 1512 is a containerization layer 1516. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1512 may also provide services 1518, which provide services and interprocess communication to userspace applications 1520.

Services 1518 and userspace applications 1520 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1512, they inherit the same file and resource access permissions as those provided by shared kernel 1508. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1504, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1504).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1504 hosts two containers, namely container 1530 and container 1540.

Container 1530 may include a minimal operating system 1532 that runs on top of shared kernel 1508. Note that a minimal operating system is provided as an illustrative example, and is not mandatory. In fact, container 1530 may perform as full an operating system as is necessary or desirable. Minimal operating system 1532 is used here as an example simply to illustrate that in common practice, the minimal operating system necessary to support the function of the container (which in common practice, is a single or monolithic function) is provided.

On top of minimal operating system 1532, container 1530 may provide one or more services 1534. Finally, on top of services 1534, container 1530 may also provide userspace applications 1536, as necessary.

Container 1540 may include a minimal operating system 1542 that runs on top of shared kernel 1508. Note that a minimal operating system is provided as an illustrative example, and is not mandatory. In fact, container 1540 may perform as full an operating system as is necessary or desirable. Minimal operating system 1542 is used here as an example simply to illustrate that in common practice, the minimal operating system necessary to support the function of the container (which in common practice, is a single or monolithic function) is provided.

On top of minimal operating system 1542, container 1540 may provide one or more services 1544. Finally, on top of services 1544, container 1540 may also provide userspace applications 1546, as necessary.

Using containerization layer 1516, containerized server 1504 may run discrete containers, each one providing the minimal operating system and/or services necessary to provide a particular function. For example, containerized server 1504 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

The foregoing outlines features of several embodiments so that those skilled in the art may better understand various aspects of the present disclosure. The foregoing detailed description sets forth examples of apparatuses, methods, and systems relating to a system providing small business security services accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without the specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

What is claimed is:

1-45. (canceled)

46. A computer-implemented method of providing security services to an enterprise, comprising:
computing, for a plurality of users for an enterprise, a plurality of user digital health scores based on respective protection statuses for a plurality of enterprise assets owned by respective users;
computing, for the enterprise, an overall enterprise security status score based on the plurality of user digital health scores;
graphically displaying to an enterprise administrator the overall enterprise security status score; and
presenting to the enterprise administrator a plurality of action recommendations to improve the overall enterprise security status score.

47. The computer-implemented method of claim 46, wherein the enterprise is a small business.

48. The computer-implemented method of claim 47, wherein the small business has fewer than 250 employees.

49. The computer-implemented method of claim 46, wherein a user digital health score is further adjusted according to notional assets of the plurality of enterprise assets.

50. The computer-implemented method of claim 49, wherein the notional assets are adjustable by an enterprise administrator.

51. The computer-implemented method of claim 46, wherein a user digital health score is further adjusted according to weights assigned to individual protection statuses for the plurality of enterprise assets.

52. The computer-implemented method of claim 46, wherein computing a user digital health score comprises computing respective sub-scores for a plurality of protection categories, and computing a weighted sum of sub-scores, wherein each sub-score is assigned a relative weight, and a sum of the relative weights is 1.0.

53. The computer-implemented method of claim 52, wherein the plurality of protection categories comprise security, identity, and privacy.

54. The computer-implemented method of claim 53, wherein a relative weight for security is higher than a relative weight for identity, and the relative weight for identity is higher than the relative weight for privacy.

55. The computer-implemented method of claim 54, further comprising computing for a user a personal digital health score that includes non-enterprise assets.

56. The computer-implemented method of claim 55, wherein the relative weights for the personal digital health score are different from the relative weights for the user digital health score.

57. The computer-implemented method of claim 46, wherein a user digital health score is computed as a weighted sum of asset protection scores for a plurality of assets owned by the respective users, wherein an asset protection score is computed as a weighted sum of boolean protection statuses for a plurality of protections available to an asset.

58. The computer-implemented method of claim 57, wherein the user digital health score is computed as a ratio relative to a perfect user digital health score.

59. The computer-implemented method of claim 46, wherein the enterprise assets are selected from a group consisting of devices, data, storage, business applications, online presence, social media, account credentials, encryption keys, digital certificates, financial assets, crypto assets, e-commerce assets, proprietary data, business identity, and personal identity.

60. One or more tangible, nontransitory computer-readable storage media having stored thereon executable instructions to instruct a processor circuit to:
compute, for a plurality of enterprise users, a plurality of user digital health scores based on respective protection statuses for a plurality of enterprise assets owned by respective users;
compute, for the enterprise, an overall enterprise security status score based on the plurality of user digital health scores;
graphically display to an enterprise administrator the overall enterprise security status score; and
present to the enterprise administrator a plurality of action recommendations to improve the overall enterprise security status score.

61. The one or more tangible, nontransitory computer-readable storage media of claim 60, wherein the enterprise is a small business.

62. The one or more tangible, nontransitory computer-readable storage media of claim 61, wherein the small business has fewer than 250 employees.

63. The one or more tangible, nontransitory computer-readable storage media of claim 60, wherein a user digital health score is further adjusted according to notional assets of the plurality of enterprise assets.

64. A computing device, personal to a user associated with a small business, comprising:
a processor circuit;
a memory, comprising personal data and business data; and
a small business security agent, comprising instructions stored on the memory to instruct the processor circuit to:
compute an enterprise digital health score according to an observed presence of available protections for the business data;
compute a personal digital health score according to an observed presence of available protections for the personal data;
send to the small business the enterprise digital health score; and
display to the user the personal digital health score, along with actionable factors that affect the personal digital health score.

65. The computing device of claim 64, wherein the small business security agent further comprises instructions to receive from a small business administrator an action directive to improve the enterprise digital health score, and to carry out the action directive on the computing device.
